(19) United States
(12) Patent Application Publication
(10) Pub. No.: US 2019/0305609 A1
(43) Pub. Date: Oct. 3, 2019

(54) MAGNETIC SHEET AND ELECTRONIC DEVICE

(71) Applicant: Samsung Electro-Mechanics Co., Ltd., Suwon-si (KR)

(72) Inventors: Doo Ho PARK, Suwon-si (KR); Jung Young CHO, Suwon-si (KR); San KYEONG, Suwon-si (KR); Sung Nam CHO, Suwon-si (KR); Ji Hyo LEE, Suwon-si (KR); Byeong Cheol MOON, Suwon-si (KR)

(73) Assignee: Samsung Electro-Mechanics Co., Ltd., Suwon-si (KR)

(21) Appl. No.: 16/163,773

(22) Filed: Oct. 18, 2018

(30) Foreign Application Priority Data
Apr. 2, 2018 (KR) 10-2018-0038222

(51) Int. Cl. H02J 50/70; G06F 1/16; G06F 1/20; H02J 50/10; H01F 38/14; H01F 7/20; H01F 10/12

(52) U.S. Cl. CPC H02J 50/70; G06F 1/1683; G06F 1/1635; H01F 10/12; H02J 50/10; H01F 38/14; H01F 7/204; G06F 1/206

(57) ABSTRACT

A magnetic sheet includes a magnetic layer, a heat radiation layer having a prominence and a depression formed in a surface and that faces the magnetic layer, and an adhesive layer disposed between the magnetic layer and the heat radiation layer, and including a heat radiation filler that has shape anisotropy.

### CROSS-REFERENCE TO RELATED APPLICATION

This application claims the benefit under 35 USC 119(a) of Korean Patent Application No. 10-2018-0038222 filed on Apr. 2, 2018 in the Korean Intellectual Property Office, the entire disclosure of which is incorporated herein by reference for all purposes.

### BACKGROUND

### 1. Field

The following description relates to a magnetic sheet and an electronic device.

### 2. Description of Related Art

In recent years, a wireless power consortium (WPC) function, a near field communications (NFC) function, a magnetic secure transmission (MST) function, and the like have been used in mobile portable apparatuses. WPC technology, NFC technology, and MST technology have differences in operating frequencies, data rates, amounts of transmitted power, and the like.

In a wireless power transmitter, a magnetic sheet serving to block and collect electromagnetic waves is used. For example, in a wireless charging apparatus, the magnetic sheet is disposed between a receiving portion coil and a battery. The magnetic sheet shields and collects a magnetic field generated in the receiving portion coil, and blocks the magnetic field from being transmitted to the battery, thereby allowing electromagnetic waves generated from the wireless power transmitter to be efficiently received by a wireless power receiver.

In accordance with multi-functionalization and improvements in the functions of the portable electronic apparatus in which such a magnetic sheet is used, improvements of performance of the magnetic sheet have been continuously demanded. In the case of performing wireless charging using the magnetic sheet, power of several to several tens of watts constantly moves, resulting in a loss of materials and circuits. As a result, a large amount of heat is generated. Therefore, in the art, research into a method for efficiently discharging heat generated from an electromagnetic wave shielding sheet, a coil part, or the like is being undertaken.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In one general aspect, a magnetic sheet includes a magnetic layer, a heat radiation layer including a prominence and a depression formed in a surface that faces the magnetic layer; and an adhesive layer disposed between the magnetic layer and the heat radiation layer, and including a heat radiation filler that has shape anisotropy.

The heat radiation filler may include a first heat radiation filler that has a flake shape, a plate shape, or a rod shape, and a length of a long axis of the first heat radiation filler may be different than a length of a minor axis of the first heat radiation filler.

The first heat radiation filler may be oriented in a thickness direction of the magnetic layer.

The adhesive layer may fill a space formed by the prominence and the depression.

A thickness of the prominence and the depression may be greater than or equal to one-fifth of a thickness of the adhesive layer.

The first heat radiation filler may be disposed in the space formed by the prominence and the depression.

The prominence and the depression may have an inclined surface that is inclined with respect to the magnetic layer, and the first heat radiation filler disposed in the space may be parallel to the inclined surface.

A surface of the first heat radiation filler in a long axis direction may face the inclined surface.

More than a half of the first heat radiation filler disposed in the space may be parallel to the inclined surface.

The length of the long axis of the first heat radiation filler may be greater than or equal to one-third of a thickness of the prominence and the depression.

The heat radiation filler may include a second heat radiation filler in a form of a nanowire.

The second heat radiation filler may connect two or more first heat radiation fillers to each other.

The second heat radiation filler may include a silver (Ag) component.

The second heat radiation filler may have a shape corresponding to a shape of the prominence and the depression.

The heat radiation filler may include a nanowire having a shape corresponding to a shape of the prominence and the depression.

The heat radiation layer may be a copper foil.

In another general aspect, an electronic device includes a coil part having a coil pattern and a magnetic sheet. The magnetic sheet includes a magnetic layer facing the coil part, a heat radiation layer including a prominence and a depression formed in a surface that faces the magnetic layer, and an adhesive layer disposed between the magnetic layer and the heat radiation layer, and including a heat radiation filler that has shape anisotropy.

The heat radiation layer may include two or more prominences and depressions and a distance between adjacent prominences and depressions may be shorter than a length of the heat radiation filler.

In another general aspect, an apparatus includes a coil part having a coil pattern, a battery, and a magnetic sheet disposed between the coil pattern and the battery. The magnetic sheet includes a magnetic layer configured to face the coil part, a heat radiation layer including a projection projecting from a surface that faces the magnetic layer, and an adhesive layer disposed between the magnetic layer and the heat radiation layer. The adhesive layer includes a heat radiation filler that has shape anisotropy.

Other features and aspects will be apparent from the following detailed description, the drawings, and the claims.

### BRIEF DESCRIPTION OF DRAWINGS

FIG. 1 is a perspective view illustrating an outer shape of a general wireless charging system.

FIG. 2 is an exploded cross-sectional view illustrating main internal components of FIG. 1.

FIG. 3 is a schematic plan view illustrating a magnetic sheet according to an example.

FIG. 4 is an enlarged view illustrating a region A in the magnetic sheet of FIG. 3.

FIGS. 5A, 5B, and 5C illustrate shapes of a heat radiation filler that may be used in the magnetic sheet of FIG. 3.

FIGS. 6 and 7, which relate to a magnetic sheet according to an example, illustrate enlarged views of the vicinity of a heat radiation layer and an adhesive layer.

Throughout the drawings and the detailed description, the same reference numerals refer to the same elements. The drawings may not be to scale, and the relative size, proportions, and depiction of elements in the drawings may be exaggerated for clarity, illustration, and convenience.

### DETAILED DESCRIPTION

The following detailed description is provided to assist the reader in gaining a comprehensive understanding of the methods, apparatuses, and/or systems described herein. However, various changes, modifications, and equivalents of the methods, apparatuses, and/or systems described herein will be apparent after an understanding of the disclosure of this application. For example, the sequences of operations described herein are merely examples, and are not limited to those set forth herein, but may be changed as will be apparent after an understanding of the disclosure of this application, with the exception of operations necessarily occurring in a certain order. Also, descriptions of features that are known in the art may be omitted for increased clarity and conciseness.

The features described herein may be embodied in different forms, and are not to be construed as being limited to the examples described herein. Rather, the examples described herein have been provided merely to illustrate some of the many possible ways of implementing the methods, apparatuses, and/or systems described herein that will be apparent after an understanding of the disclosure of this application.

Herein, it is noted that use of the term “may” with respect to an example or embodiment, e.g., as to what an example or embodiment may include or implement, means that at least one example or embodiment exists in which such a feature is included or implemented while all examples and embodiments are not limited thereto.

Throughout the specification, when an element, such as a layer, region, or substrate, is described as being “on,” “connected to,” or “coupled to” another element, it may be directly “on,” “connected to,” or “coupled to” the other element, or there may be one or more other elements intervening therebetween. In contrast, when an element is described as being “directly on,” “directly connected to,” or “directly coupled to” another element, there can be no other elements intervening therebetween.

As used herein, the term “and/or” includes any one and any combination of any two or more of the associated listed items.

Although terms such as “first,” “second,” and “third” may be used herein to describe various members, components, regions, layers, or sections, these members, components, regions, layers, or sections are not to be limited by these terms. Rather, these terms are only used to distinguish one member, component, region, layer, or section from another member, component, region, layer, or section. Thus, a first member, component, region, layer, or section referred to in examples described herein may also be referred to as a second member, component, region, layer, or section without departing from the teachings of the examples.

Spatially relative terms such as “above,” “upper,” “below,” and “lower” may be used herein for ease of description to describe one element's relationship to another element as shown in the figures. Such spatially relative terms are intended to encompass different orientations of the device in use or operation in addition to the orientation depicted in the figures. For example, if the device in the figures is turned over, an element described as being “above” or “upper” relative to another element will then be “below” or “lower” relative to the other element. Thus, the term “above” encompasses both the above and below orientations depending on the spatial orientation of the device. The device may also be oriented in other ways (for example, rotated 90 degrees or at other orientations), and the spatially relative terms used herein are to be interpreted accordingly.

The terminology used herein is for describing various examples only, and is not to be used to limit the disclosure. The articles “a,” “an,” and “the” are intended to include the plural forms as well, unless the context clearly indicates otherwise. The terms “comprises,” “includes,” and “has” specify the presence of stated features, numbers, operations, members, elements, and/or combinations thereof, but do not preclude the presence or addition of one or more other features, numbers, operations, members, elements, and/or combinations thereof.

Due to manufacturing techniques and/or tolerances, variations of the shapes shown in the drawings may occur. Thus, the examples described herein are not limited to the specific shapes shown in the drawings, but include changes in shape that occur during manufacturing.

The features of the examples described herein may be combined in various ways as will be apparent after an understanding of the disclosure of this application. Further, although the examples described herein have a variety of configurations, other configurations are possible as will be apparent after an understanding of the disclosure of this application.

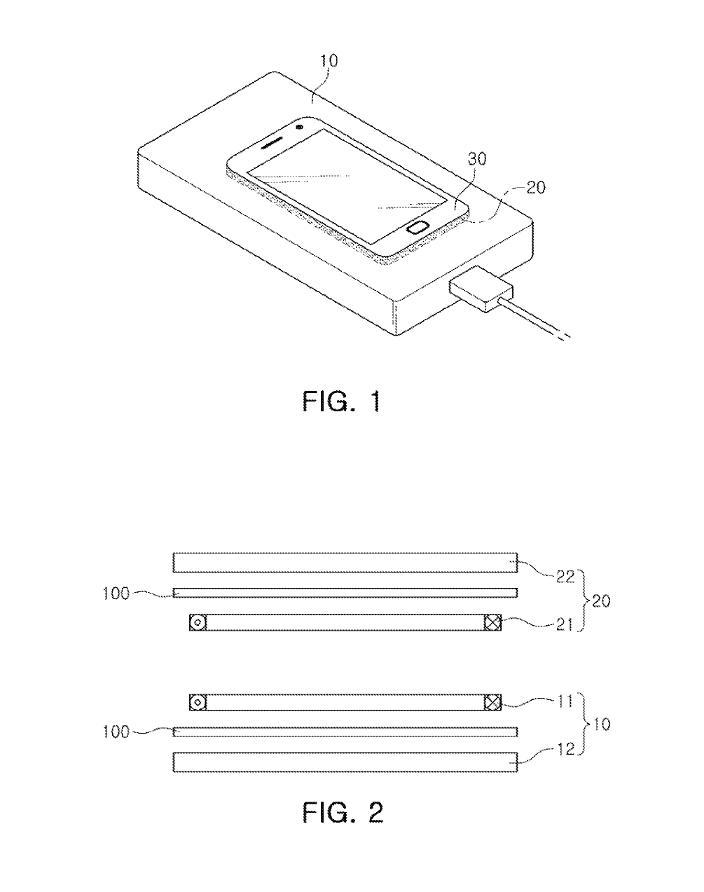

FIG. 1 is a schematic perspective view illustrating an outer shape of a general wireless charging system and FIG. 2 is an exploded cross-sectional view illustrating main internal components of FIG. 1.

Referring to FIGS. 1 and 2, a general wireless charging system may include a wireless power transmitter 10 and a wireless power receiver 20, and the wireless power receiver 20 may be included in an electronic device 30 such as a mobile phone, a notebook, a tablet personal computer (PC), or the like.

The wireless power transmitter 10 may include a transmit part coil 11 formed on a substrate 12. When an alternating current (AC) voltage is applied to the wireless power transmitter 10, a magnetic field may be formed around the wireless power transmitter 10. Electromotive force may be induced from the transmit part coil 11 into a receiving portion coil 21 embedded in the wireless power receiver 20, such that a battery 22 may be charged.

The battery 22 may be a nickel metal hydride battery or a lithium ion battery that is rechargeable, but is not particularly limited to such types of batteries. The battery 22 may be configured separately from the wireless power receiver 20 and be detachable from the wireless power receiver 20, or may be in an integral form in which the battery 22 and wireless power receiver 20 are configured integrally.

The transmit part coil 11 and the receiving portion coil 21 may be electromagnetically coupled to each other and may be formed by winding a metal wire formed of copper or the like. A wound shape of the transmit part coil 11 and the receiving portion coil 21 may be a circular shape, an oval shape, a quadrangular shape, a rhombic shape, or the like, and the entire sizes, the turns, or the like, of the transmit part coil 11 and the receiving portion coil 21 may be appropriately controlled and set depending on desired properties.

Magnetic sheets 100 may be disposed between the receiving portion coil 21 and the battery 22 and between the transmit part coil 11 and the substrate 12, respectively. The magnetic sheet 100 may shield a magnetic flux formed at a central portion of the transmit part coil 11, and when the magnetic sheet 100 is disposed in a receiving portion side, the magnetic sheet 100 may be positioned between the receiving portion coil 21 and the battery 22 and collect a magnetic flux to allow the magnetic flux to be efficiently received by the receiving portion coil 21. The magnetic sheet 100 may serve to block at least some of the magnetic flux from being transmitted to the battery 22.

The magnetic sheet 100 may be coupled to a coil part and be used in a receiving portion of the wireless charging apparatus described above. The coil part may be used in magnetic secure transmission (MST), near field communications (NFC), or the like, in addition to the wireless charging apparatus. Both of the transmit part coil and the receiving portion coil will hereinafter be referred to as coil parts when they do not need to be distinguished from each other. The magnetic sheet 100 will hereinafter be described in more detail.

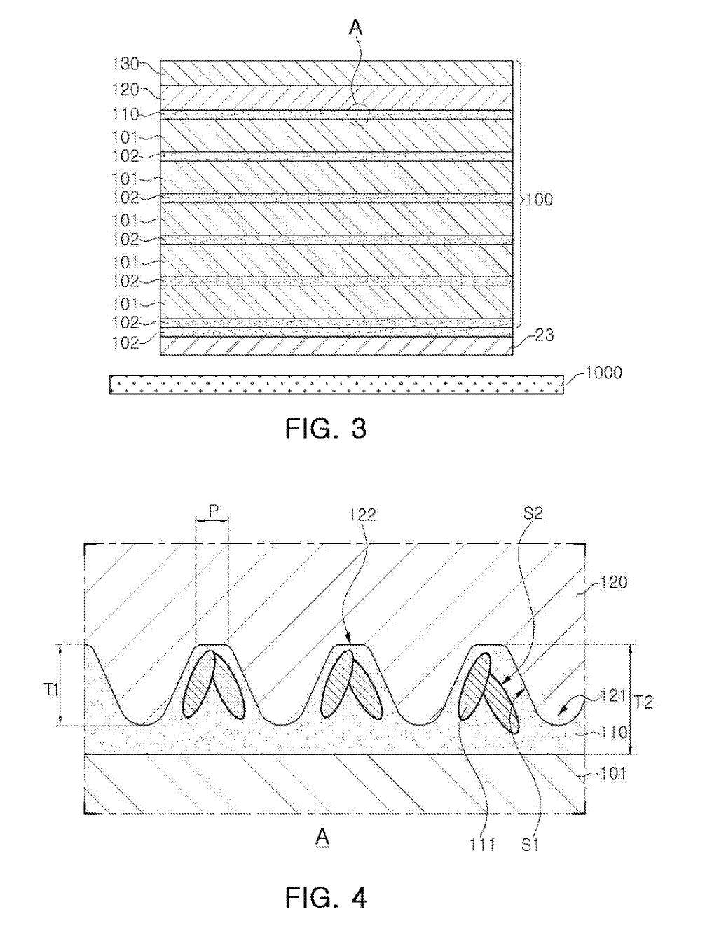

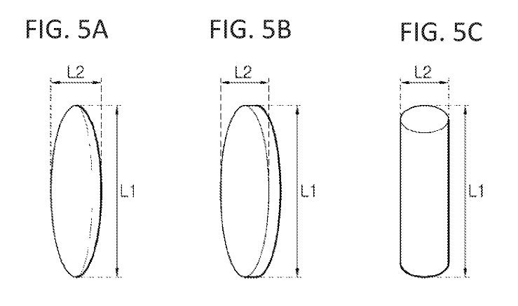

FIG. 3 is a schematic cross-sectional view illustrating a magnetic sheet according to an example. FIG. 4 is an enlarged view illustrating a region A in the magnetic sheet of FIG. 3 and corresponds to a state before a heat treatment. FIGS. 5A through 5C illustrate shapes of a heat radiation filler which may be used in the magnetic sheet of FIG. 3.

Referring to FIGS. 3 and 4, the magnetic sheet 100 may include a magnetic layer 101, a heat radiation layer 120, and an adhesive layer 110 disposed between the magnetic layer 101 and the heat radiation layer 120. The example will be described based on a receive side shielding structure positioned inside a cover 1000 of a mobile device, but the magnetic sheet 100 may also be applied to a transmit side shielding structure.

The magnetic layer 101 may serve to block, collect, and the like electromagnetic waves in the wireless charging apparatus, and the magnetic sheet 100 may have a structure in which a plurality of magnetic layers 101 are stacked. The plurality of magnetic layers 101 may be coupled to adhesive layers 102 interposed therebetween. The magnetic layer 101 may be coupled to a coil part 23 (transmit part coil 11 or receiving portion coil 21) and the adhesive layer 102 may be formed on one surface of the coil part 23. The magnetic sheet 100 may be disposed such that the magnetic layer 101 is directed to (faces) the coil part 23 and not the heat radiation layer 120 with respect to an arrangement direction of the magnetic sheet 100.

The magnetic layer 101 may be formed of a material having magnetic property so as to be suitable for electromagnetic wave shielding, and may include, for example, an alloy, a ferrite, and the like. Examples of the alloy that may be included in the magnetic layer 101 may include an amorphous alloy or a nano-crystalline alloy, and the magnetic layer 101 may be implemented as a thin metal ribbon formed of the alloys described above. The magnetic layer 101 may use a Fe-based nano-crystalline magnetic alloy, and may use, for example, a Fe—Si—B—Cu—Nb alloy. In order to form the nano-crystalline alloy, the amorphous metal obtained in the form of ribbon or the like may be heat-treated at an appropriate temperature. Examples of the ferrite that may be included in the magnetic layer 101 may include a Mn—Zn-based ferrite, a Mn—Ni-based ferrite, Ba, an Sr-based ferrite, and the like.

The adhesive layer 102 may be an adhesive material such as a resin composition, and may be a material that physically bonds the adjacent magnetic layers 101 to each other or forms a chemical bond with the magnetic layer 101, or the like. The adhesive layer 102 is not a necessary component in the example, but may be omitted in some configurations.

A protective layer 130 may be disposed on the heat radiation layer 120 to protect the magnetic sheet 100, and may include a polymer based material such as PET or the like. Although not illustrated, an additional adhesive layer may be interposed between the protective layer 130 and the heat radiation layer 120, and a black PET layer or the like may be interposed between the protective layer 130 and the heat radiation layer 120.

Heat generated in the magnetic layer 101 or the like may be effectively discharged through the heat radiation layer 120. As illustrated in FIG. 4, the heat radiation layer 120 has a prominence and a depression 121 formed on a surface for this purpose. The prominence and the depression 121 may refer to a projection that extends from a surface of the heat radiation layer 120 and projects into the adhesive layer 110 in a direction of the magnetic layer 101. The prominence and the depression 121 on the surface of the heat radiation layer 120 may be disposed to be directed to (to face) the magnetic layer 101. The adhesive layer 110 disposed between the heat radiation layer 120 and the magnetic layer 101 may include a heat radiation filler 111 having shape anisotropy, which may be referred to as a first heat radiation filler 111. Here, the shape anisotropy is a shape in which lengths of a long (major) axis L1 and a minor axis L2 are different from each other, and may include a flake shape (FIG. 5A), a plate shape (FIG. 5B), and a rod shape (FIG. 5C) as illustrated in FIGS. 5A through 5C.

A heat radiation efficiency between the magnetic layer 101 and the heat radiation layer 120 may be improved by forming the prominence and the depression 121 on the surface of the heat radiation layer 120. This is because thermal conductivity of the adhesive layer 110 is remarkably low. For example, when the magnetic layer 101 is formed of an Fe alloy ribbon, the magnetic layer 101 may have a thermal conductivity coefficient of about 12 W/m*K, while the adhesive layer 110 formed of a polymer-based material may have a thermal conductivity coefficient of about 0.5 to 0.6 W/m*K. Therefore, a heat transfer efficiency from the magnetic layer 101 to the heat radiation layer 120 may be improved when the heat radiation layer 120 having the prominence and the depression 121 is used, as compared with a case in which the heat radiation layer has a flat surface.

The heat radiation layer 120 may be formed of a material having high thermal conductivity and in which the prominence and the depression 121 may be easily formed on the surface, and the material may include a metallic component such as copper (Cu), silver (Ag), nickel (Ni), or the like. The heat radiation layer 120 may be representatively formed in the form of copper foil. The prominence and the depression 121 may be formed on the surface of the heat radiation layer 120 in the form of copper foil using an etching process or the like.

In order to further improve the heat transfer efficiency in a vertical direction, a first heat radiation filler 111 may be oriented in a thickness direction of the magnetic layer 101 (a vertical direction with reference to FIG. 4), and the shape and effect of the orientation of the first heat radiation filler 111 will be described below. The first heat radiation filler 111 may include a metal such as copper (Cu), nickel (Ni), silver (Ag), or the like, or a material having high thermal conductivity such as graphite, graphene, or the like.

The adhesive layer 110 may include the same adhesive component as that of the adhesive layer 102 coupling the magnetic layers 101 to each other, and may also include a different kind of adhesive component to contain the shape anisotropic filler 111. As illustrated in FIG. 4, the adhesive layer 110 may fill a space 122 formed by the prominence and the depression 121 and the coupling force between the adhesive layer 110 and the heat radiation layer 120 may thus be improved. At least a portion of the first heat radiation filler 111 may be disposed in the space 122 formed by the prominence and the depression 121. As the first heat radiation filler 111 is disposed in the space 122 between the prominence and the depressions 121, an orientation structure of the first heat radiation filler 111 in the vertical direction may be effectively implemented. In a case of the absence of the prominence and the depression 121, even if the heat radiation filler having shape anisotropy is used, the heat radiation filler tends to be aligned in a horizontal direction rather than the vertical direction. The heat radiation filler aligned in the horizontal direction does not have high heat transfer efficiency to the heat radiation layer, and an adhesive function of the adhesive layer may be deteriorated when the amount of the heat radiation filler is increased to increase the heat transfer efficiency. Since the first heat radiation filler 111 may be effectively oriented by the prominence and the depression 121 in the example, an adhesive performance of the adhesive layer 110, together with an excellent heat radiation effect, may be achieved.

In order to implement the vertical alignment structure of the first heat radiation filler 111, sizes of the first heat radiation filler 111 and the prominence and the depression 121 may be modified. At least a portion of the first heat radiation filler 111 may have a length L1 of the long axis greater than or equal to ⅓ of a thickness T1 of the prominence and the depression 121, and this is because a vertical orientation degree of the first heat radiation filler 111 may be lowered when the size of the prominence and the depression 121 is too large as compared with the first heat radiation filler 111. A distance P between the prominences and depressions 121 may also affect orientation property of the first heat radiation filler 111. For example, at least a portion of the first heat radiation filler 111 may have the length L1 of the long axis greater than the distance P between the prominences and depressions 121. When the distance P between the prominences and depressions 121 is too large as compared with the length L1 of the first heat radiation filler 111, the first heat radiation filler 111 may be oriented in the horizontal direction instead of the vertical direction. The thickness T1 of the prominence and the depression 121 may be configured to be equal to or greater than ⅕ times the thickness T2 of the adhesive layer 110, as an intended heat radiation effect may not be obtained when the thickness of the adhesive layer 110 is excessively large.

The first heat radiation filler 111 may be oriented in the vertical direction to improve the heat radiation performance. However, the vertical direction does not mean that the first heat radiation filler 111 is disposed to be exactly perpendicular to a horizontal plane, but means that the first heat radiation filler 111 is substantially oriented to be closer to the vertical than the horizontal. Referring to FIG. 4, the prominence and the depression 121 may have an inclined surface S1 inclined with respect to the magnetic layer 101, and at least a portion of the first heat radiation filler 111 disposed in the space 122 formed by the prominence and the depressions 121 may be disposed to be in parallel to the inclined surface S1 of the prominence and the depression 121. The portion of the first heat radiation filler 111 disposed to be in parallel to the inclined surface S1 of the prominence and the depression 121 may be disposed so that a surface S2 of the first heat radiation filler 111 oriented in the long axis is directed to the inclined surface S1. Here, “disposed to be in parallel to” does not mean that the inclined surface S1 of the prominence and the depression 121 and the oriented surface S2 of the first heat radiation filler 111 are necessarily disposed to be in parallel to each other, but means that the inclined surface S1 of the prominence and the depression 121 and the oriented surface S2 of the first heat radiation filler 111 face each other. As an example in which the first heat radiation filler 111 is vertically oriented with respect to an overall orientation property of the first heat radiation filler 111, the portion of the first heat radiation filler 111 disposed to be in parallel to the inclined surface S1 of the prominence and the depression 121 may be more than half of the entire first heat radiation filler 111.

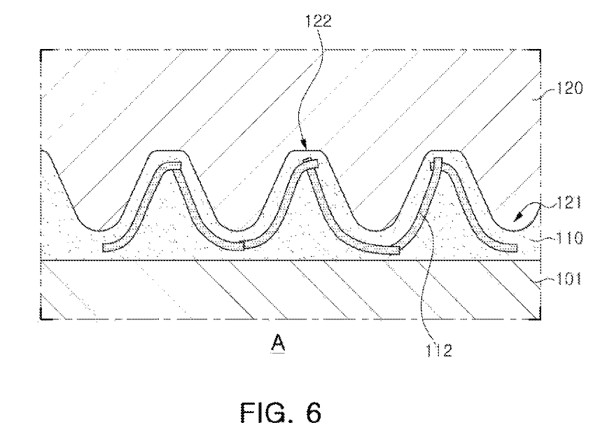

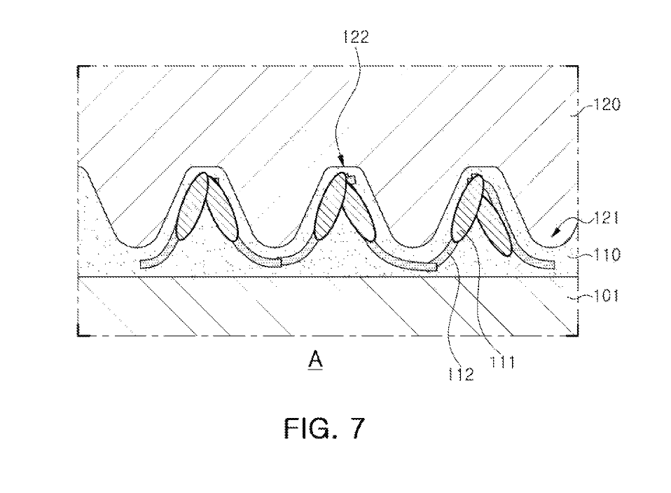

FIGS. 6 and 7, which relate to a magnetic sheet according to an example, illustrate enlarged views of the vicinity of a heat radiation layer and an adhesive layer. In FIG. 6, the heat radiation filler may be implemented in the form of a nanowire 112. The nanowire 112 may include a material such as silver (Ag), copper (Cu), nickel (Ni), or the like having high thermal conductivity, and for example, a silver (Ag) nanowire may be used. As illustrated, at least a portion of the nanowire 112 may follow a shape of the prominence and the depression 121, and an effective heat radiation path between the magnetic layer 101 and the heat radiation layer 120 may be thus provided.

FIG. 7 illustrates a structure in which the first heat radiation filler 111 and the second heat radiation filler 112 are included in the adhesive layer 110. The first heat radiation filler 111 may be the filler having the shape anisotropy, and the second heat radiation filler 112 may be the nanowire. In this example, the second heat radiation filler 112 may follow the shape of the prominence and the depression 121 and may further connect the first heat radiation fillers 111 to each other. In a case in which two kinds of heat radiation fillers 111 and 112 having different shapes are utilized, since the heat radiation path between the heat radiation fillers 111 and 112 may be further secured, the heat radiation performance may be further improved.

According to the examples, since the magnetic sheet may effectively discharge the heat generated during an operation such as a wireless charging or the like, reliability may be improved when the magnetic sheet is used in an electronic device.

While this disclosure includes specific examples, it will be apparent after an understanding of the disclosure of this application that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner, and/or replaced or supplemented by other components or their equivalents. Therefore, the scope of the disclosure is defined not by the detailed description, but by the claims and their equivalents, and all variations within the scope of the claims and their equivalents are to be construed as being included in the disclosure.

What is claimed is:

1. A magnetic sheet comprising:
a magnetic layer;
a heat radiation layer comprising a prominence and a depression formed in a surface that faces the magnetic layer; and
an adhesive layer disposed between the magnetic layer and the heat radiation layer, and comprising a heat radiation filler that has shape anisotropy.

2. The magnetic sheet of claim 1, wherein the heat radiation filler comprises a first heat radiation filler that has a flake shape, a plate shape, or a rod shape, and
a length of a long axis of the first heat radiation filler is different than a length of a minor axis of the first heat radiation filler.

3. The magnetic sheet of claim 2, wherein the first heat radiation filler is oriented in a thickness direction of the magnetic layer.

4. The magnetic sheet of claim 2, wherein the adhesive layer fills a space formed by the prominence and the depression.

5. The magnetic sheet of claim 4, wherein a thickness of the prominence and the depression is greater than or equal to one-fifth of a thickness of the adhesive layer.

6. The magnetic sheet of claim 4, wherein the first heat radiation filler is disposed in the space formed by the prominence and the depression.

7. The magnetic sheet of claim 6, wherein the prominence and the depression has an inclined surface that is inclined with respect to the magnetic layer, and
the first heat radiation filler disposed in the space is parallel to the inclined surface.

8. The magnetic sheet of claim 7, wherein a surface of the first heat radiation filler in a long axis direction faces the inclined surface.

9. The magnetic sheet of claim 7, wherein more than a half of the first heat radiation filler disposed in the space is parallel to the inclined surface.

10. The magnetic sheet of claim 2, wherein the length of the long axis of the first heat radiation filler is greater than or equal to one-third of a thickness of the prominence and the depression.

11. The magnetic sheet of claim 2, wherein the heat radiation filler comprises a second heat radiation filler in a form of a nanowire.

12. The magnetic sheet of claim 11, wherein the second heat radiation filler is configured to connect two or more first heat radiation fillers to each other.

13. The magnetic sheet of claim 11, wherein the second heat radiation filler comprises a silver (Ag) component.

14. The magnetic sheet of claim 11, wherein the second heat radiation filler has a shape corresponding to a shape of the prominence and the depression.

15. The magnetic sheet of claim 1, wherein the heat radiation filler comprises a nanowire having a shape corresponding to a shape of the prominence and the depression.

16. The magnetic sheet of claim 1, wherein the heat radiation layer is a copper foil.

17. An electronic device comprising:
a coil part comprising a coil pattern; and
a magnetic sheet comprising
a magnetic layer configured to face the coil part,
a heat radiation layer comprising a prominence and a depression formed in a surface that faces the magnetic layer, and
an adhesive layer disposed between the magnetic layer and the heat radiation layer, and comprising a heat radiation filler that has shape anisotropy.

18. The electronic device of claim 17, wherein the heat radiation layer comprises two or more prominences and depressions and a distance between adjacent prominences and depressions is shorter than a length of the heat radiation filler.

19. An apparatus comprising:
a coil part comprising a coil pattern;
a battery; and
a magnetic sheet disposed between the coil pattern and the battery and comprising
a magnetic layer configured to face the coil part,
a heat radiation layer comprising a projection projecting from a surface that faces the magnetic layer, and
an adhesive layer disposed between the magnetic layer and the heat radiation layer, and comprising a heat radiation filler that has shape anisotropy.
